(19) United States
(12) Patent Application Publication
(10) Pub. No.: US 2023/0077682 A1
(43) Pub. Date: Mar. 16, 2023

(54) STRUCTURE FOR REAL-TIME AUDIO SIGNAL PROCESSING AND CONVERTING INTO PROGRAMMABLE CONTROL SYSTEM

(71) Applicants: Aaron Raymond Ang SEE, Taoyuan (TW); Chun-Hsiang Yang, Taoyuan (TW)

(72) Inventors: Aaron Raymond Ang SEE, Taoyuan (TW); Chun-Hsiang Yang, Taoyuan (TW)

(73) Assignee: AsianLink Technology Incorporation, Taoyuan (TW)

(21) Appl. No.: 17/477,390

(22) Filed: Sep. 16, 2021

(51) Int. Cl. G08C 23/02; F21S 10/06

(52) U.S. Cl. CPC G08C 23/02; F21S 10/06

(57) ABSTRACT

A structure for real-time audio signal processing and converting into a programmable control system comprises a sound processing unit comprising first and second audio transforming modules and receiving an audio energy, the transforming modules capture the audio energy and generate first and second frequency values, the sound processing unit captures the audio energy and obtains an audio energy value; and a data storage unit storing first, second and third storage data and electrically connected to the sound processing unit that compares the first frequency value with the first storage data, compares the second frequency value with the second storage data, and compares the audio energy value with the third storage data to generate first, second and third control signals, further generates a combinational transformed data for comparing with a fourth storage data to generate an advanced control signal that controls an electronic device to generate a corresponding action.

### BACKGROUND OF THE INVENTION

### Field of Invention

The invention relates to a structure, and more particularly to a structure capable of receiving an audio signal, processing the audio signal in real time, and converting into a programmable control system.

### Related Art

With the advancement of technology and the improvement of people's living standards, people's demand for quality of life is beginning to increase, and music playback is an element of the basic quality of life. Therefore, many people play music through speakers, but playing music only through speakers is relatively monotonous, so there are many control systems designed to control the electronic device to produce corresponding action in response to the playback of music. For example, when the control system receives an audio signal, the control system will control the electronic device to generate a light change corresponding to the audio signal, and the conventional control system mainly receives a measured tempo of the audio signal, which is commonly known as musical rhythm (BPM, beats per minute). The control system first needs to capture the complete waveform of the audio signal in the set loop time interval before receiving the measured tempo to generate corresponding action, the control system then calculates the average value of the captured audio signal to obtain the measured tempo, and then controls the electronic device to produce corresponding action according to the measured tempo, so the control system needs to capture the complete waveform in order to be capable of calculating the measured tempo. However, there is a time difference in capturing between generation of the audio signal and the action of the electronic device, which causes the control system being incapable of making the electronic device produce synchronous control effect in real time while the audio signal is generated.

Therefore, the inventor of the invention and relevant manufacturers engaged in this industry are eager to research and make improvement to solve the above-mentioned problems and drawbacks in the prior art.

### SUMMARY OF THE INVENTION

Therefore, in order to effectively solve the above-mentioned problems, a main object of the invention is to provide a structure capable of receiving an audio signal, processing the audio signal in real time, and converting into a programmable control system.

In order to achieve the above object, the invention provides a structure for real-time audio signal processing and converting into a programmable control system at least comprising a sound processing unit, the sound processing unit comprising a first audio transforming module and a second audio transforming module, also the sound processing unit receiving an audio energy, the first audio transforming module capturing the audio energy and converting the audio energy into a first frequency value, the second audio transforming module capturing a frequency of the highest energy in the audio energy to generate a second frequency value, the sound processing unit capturing the audio energy and obtaining an audio energy value; and a data storage unit, the data storage unit storing a plurality of first storage data, a plurality of second storage data, and a plurality of third storage data and being electrically connected to the sound processing unit, the sound processing unit comparing the first frequency value with the first storage data to generate a first control signal, the sound processing unit comparing the second frequency value with the second storage data to generate a second control signal, the sound processing unit comparing the audio energy value with the third storage data to generate a third control signal, and the sound processing unit transmitting the first control signal, the second control signal, and the third control signal to a control signal unit.

According to one embodiment of the structure for real-time audio signal processing and converting into the programmable control system of the invention, further comprising an audio receiving unit, the audio receiving unit receiving an audio signal generated by at least one audio playback device and being electrically connected to the sound processing unit, and the sound processing unit receiving an audio energy of the audio signal.

According to one embodiment of the structure for real-time audio signal processing and converting into the programmable control system of the invention, further comprising an electronic device, the electronic device being electrically connected to the control signal unit, the electronic device being provided with at least one controlled component, the control signal unit controlling the controlled component of the electronic device to generate a corresponding action through the first control signal, the second control signal, and the third control signal.

According to one embodiment of the structure for real-time audio signal processing and converting into the programmable control system of the invention, wherein the first audio transforming module is fast Fourier transform filter detection.

According to one embodiment of the structure for real-time audio signal processing and converting into the programmable control system of the invention, wherein the second audio transforming module is Mel-frequency filter bank filter detection.

According to one embodiment of the structure for real-time audio signal processing and converting into the programmable control system of the invention, wherein the controlled component is a light-emitting element, and the first control signal controls the light-emitting element to generate a corresponding light color.

According to one embodiment of the structure for real-time audio signal processing and converting into the programmable control system of the invention, wherein the controlled component is a light-emitting element, and the second control signal controls the light-emitting element to generate a corresponding light flickering rhythm.

According to one embodiment of the structure for real-time audio signal processing and converting into the programmable control system of the invention, wherein the controlled component is a light-emitting element, and the third control signal controls the light-emitting element to generate a corresponding light brightness.

According to one embodiment of the structure for real-time audio signal processing and converting into the programmable control system of the invention, wherein when the sound processing unit generates the first control signal, the second control signal, and the third control signal simultaneously, the sound processing unit further generates a combinational transformed data, the sound processing unit compares the combinational transformed data with a fourth storage data of the data storage unit to generate an advanced control signal, and the advanced control signal controls the controlled component of the electronic device to generate a corresponding action.

According to one embodiment of the structure for real-time audio signal processing and converting into the programmable control system of the invention, further comprising a programming unit, the programming unit being electrically connected to the data storage unit, and the programming unit generating the first storage data, the second storage data, the third storage data, and the fourth storage data to be stored in the data storage unit.

### BRIEF DESCRIPTION OF THE DRAWINGS

FIG. 1 is a block diagram of a structure for real-time audio signal processing and converting into a programmable control system of the invention;

FIG. 2 is a first implementation diagram of the structure for real-time audio signal processing and converting into the programmable control system of the invention; and

FIG. 3 is a second implementation diagram of the structure for real-time audio signal processing and converting into the programmable control system of the invention.

### DETAILED DESCRIPTION OF THE INVENTION

In the following, for the formation and technical content related to a structure for real-time audio signal processing and converting into a programmable control system of the invention, various applicable examples are exemplified and explained in detail with reference to the accompanying drawings; however, the invention is of course not limited to the enumerated embodiments, drawings, or detailed descriptions.

Furthermore, those who are familiar with this technology should also understand that the enumerated embodiments and accompanying drawings are only for reference and explanation, and are not used to limit the invention; other modifications or alterations that can be easily implemented based on the detailed descriptions of the invention are also deemed to be within the scope without departing from the spirit or intention thereof as defined by the appended claims and their legal equivalents.

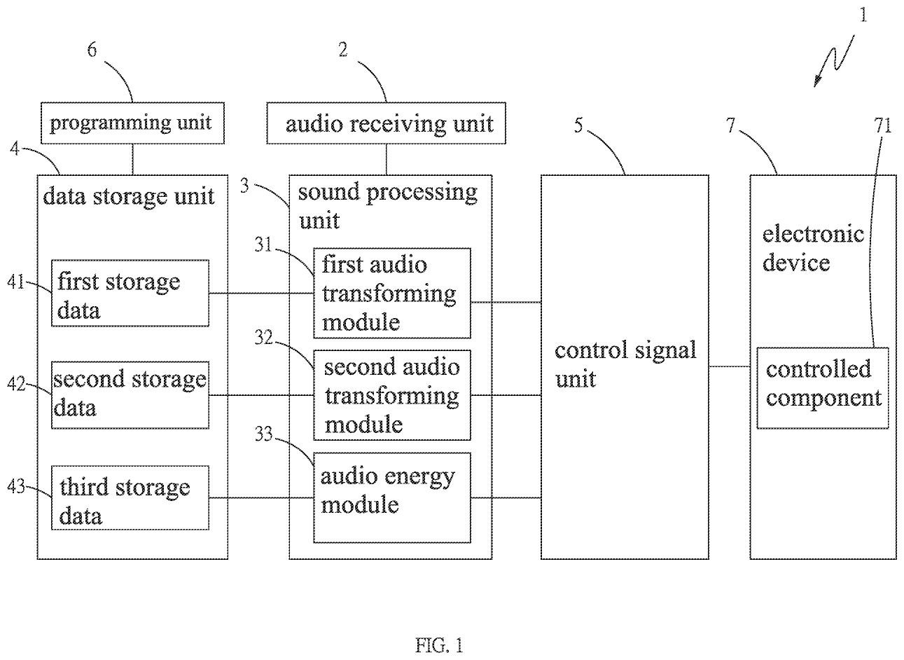

First of all, please refer to FIG. 1 for a block diagram of a structure for real-time audio signal processing and converting into a programmable control system of the invention. It can be clearly seen from the figure that a control system 1 comprises an audio receiving unit 2, a sound processing unit 3, a data storage unit 4, a control signal unit 5, a programming unit 6, and an electronic device 7.

Wherein the audio receiving unit 2 is electrically connected to the sound processing unit 3, the sound processing unit 3 comprises a first audio transforming module 31, a second audio transforming module 32, and an audio energy module 33, the first audio transforming module 31 is fast Fourier transform filter detection, and the second audio transforming module 32 is Mel-frequency filter bank filter detection.

Wherein the data storage unit 4 is electrically connected to the sound processing unit 3, the data storage unit 4 stores a plurality of first storage data 41, a plurality of second storage data 42, and a plurality of third storage data 43, and the sound processing unit 3 is electrically connected to the control signal unit 5 at the same time.

Wherein the programming unit 6 is electrically connected to the data storage unit 4, the programming unit 6 generates the first storage data 41, the second storage data 42 and the third storage data 43 by programming, the programming unit 6 stores the first storage data 41, the second storage data 42 and the third storage data 43 in the data storage unit 4, and the programming unit 6 is capable of modifying the first storage data 41, the second storage data 42 and the third storage data 43 and storing the first storage data 41, the second storage data 42 and the third storage data 43 in the data storage unit 4.

Wherein the electronic device 7 is electrically connected to the control signal unit 5, the electronic device 7 is provided with at least one controlled component 71, the controlled component 71 can be a light-emitting element, but is not limited thereto, the controlled component 71 can also be an action mechanism of the electronic device 7, and in this embodiment, the controlled component 71 is implemented as a light-emitting element.

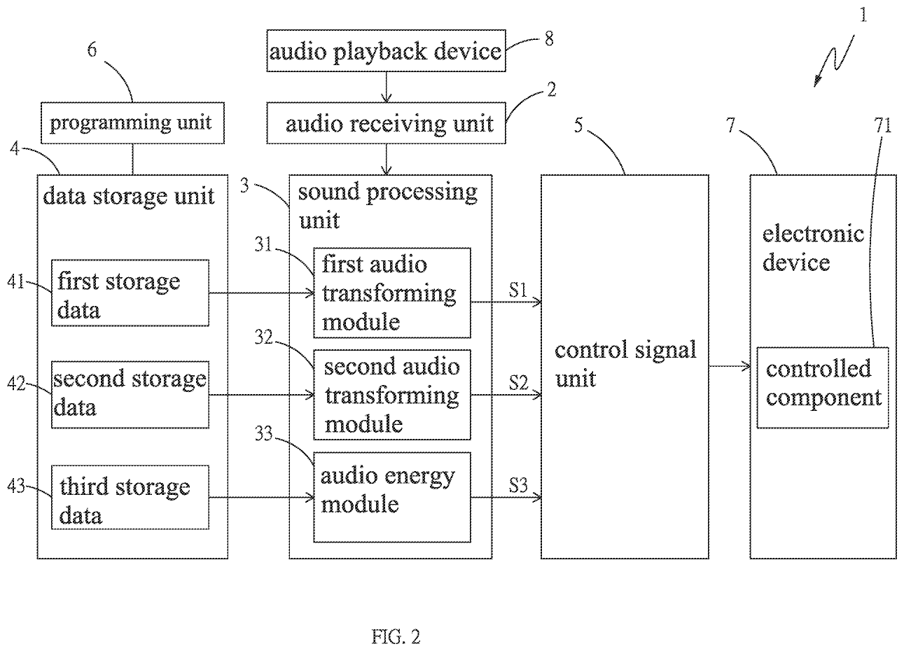

Please refer to the foregoing figure as well as FIG. 2 for a first implementation diagram of the structure for real-time audio signal processing and converting into the programmable control system 1 of the invention. Wherein when the control system 1 is implemented, the audio receiving unit 2 receives an audio signal generated by at least one audio playback device 8, the audio receiving unit 2 receives the audio signal and transmits the audio signal to the sound processing unit 3, and the sound processing unit 3 receives an audio energy of the audio signal. After the sound processing unit 3 receives the audio energy, the first audio transforming module 31 inputs the audio energy of the highest frequency into a fast Fourier transform filter to detect and transform the audio energy of the highest frequency into a first frequency value within one second. After the first audio transforming module 31 generates the first frequency value, the sound processing unit 3 simultaneously captures the first frequency value and the first storage data 41, compares the first frequency value with the first storage data 41, and generates a first control signal S1, and the first control signal S1 is transmitted to the control signal unit 5. The control signal unit 5 controls the light-emitting element to generate a corresponding light color through the first control signal S1, for example: red light source if the data in the first storage data 41 is 10˜50 hz, blue light source for 51˜99 hz, and purple light source for 100˜200 hz. When the first frequency value is 90 hz, the sound processing unit 3 compares and determines that the first frequency value falls within the range of 51˜99 hz of the first storage data 41, so the control signal unit 5 controls the light-emitting element to generate a blue light source.

In addition, the second audio transforming module 32 uses the Mel-frequency filter bank filter detection to capture a frequency of the highest energy in the audio energy to generate a second frequency value within one second. After the second audio transforming module 32 generates the second frequency value, the sound processing unit 3 simultaneously captures a musical beat (Hz multiplied by 60 seconds) of the second frequency value for comparing with the second storage data 42 and generates a second control signal S2. The second control signal S2 is transmitted to the control signal unit 5, and the control signal unit 5 controls the light-emitting element to generate a corresponding light flickering rhythm through the second control signal S2, that is, a flickering speed of light source is controlled through the second control signal S2; for example: fast speed flickering light if the data in the second storage data 42 is 134˜196 bpm, normal speed flickering light for 71˜133 bpm, and slow speed flickering light for 1˜70 bpm. When a musical beat (Hz multiplied by 60 seconds) of the second frequency value is 50 bpm, the sound processing unit 3 compares and determines that the musical beat (Hz multiplied by 60 seconds) of the second frequency value falls within the range of 1˜70 bpm of the second storage data 42, so the control signal unit controls the light-emitting element to generate a slow speed flickering light.

In addition, the audio energy module 33 of the sound processing unit 3 captures the audio energy and obtains an audio energy value. After the audio energy module 33 generates the audio energy value, the sound processing unit 3 simultaneously captures the audio energy value, compares the audio energy value with the third storage data 43, and generates a third control signal S3. The third control signal S3 is transmitted to the control signal unit 5, and the control signal unit 5 controls the light-emitting element to generate a corresponding light brightness through the third control signal S3, that is, a brightness of light source is controlled through the third control signal S3; for example: high light brightness if the data in the third storage data 43 is 70˜115db, normal light brightness for 40˜76db, and low light brightness for 3˜42db. When the third frequency value is 59db, the sound processing unit 3 compares and determines that the third frequency value falls within the range of 40˜76db of the third storage data 43, so the control signal unit 5 controls the light-emitting element to generate a normal light brightness.

Thereby, the sound processing unit 3 of the control system 1 is capable of processing the audio signal in real time when the audio playback device 8 generates the audio signal, and performing transformation through self-programmed lighting effects, and controlling the electronic device 7 to generate corresponding light source color, flickering speed, and light source brightness within one second, so that the electronic device 7 is capable of instantaneously generating a light source effect synchronized with the audio signal.

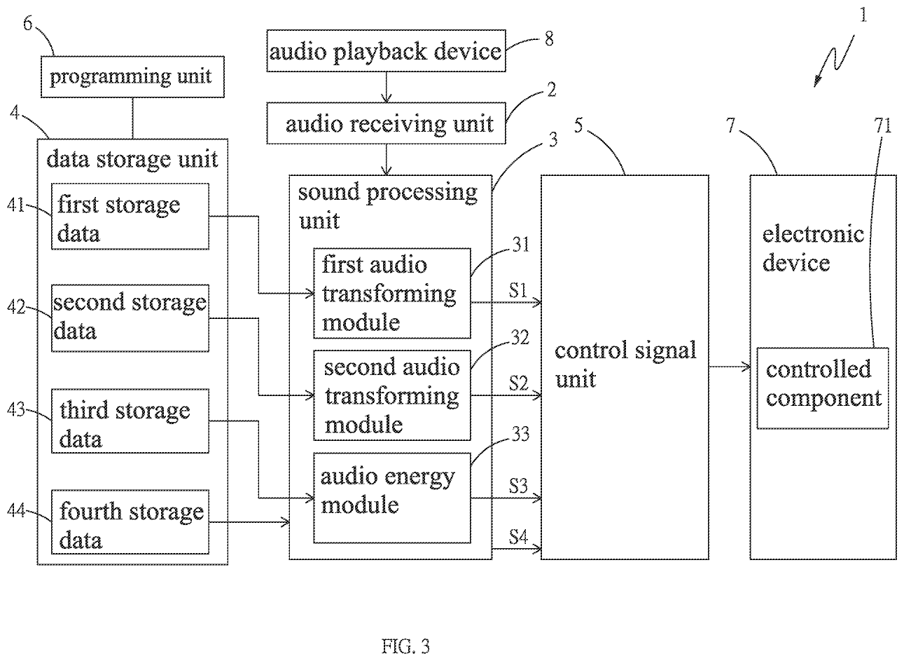

Please refer to the foregoing figures as well as FIG. 3 for a second implementation diagram of the structure for real-time audio signal processing and converting into the programmable control system 1 of the invention. Wherein the data storage unit 4 further stores a fourth storage data 44, the fourth storage data 44 is generated by programming by the programming unit 6, and the programming unit 6 stores the fourth storage data 44 in the data storage unit 4. When the sound processing unit 3 generates the first control signal S1, the second control signal S2, and the third control signal S3 simultaneously, the sound processing unit 3 further generates a combinational transformed data, the sound processing unit 3 simultaneously captures the combinational transformed data and the fourth storage data 44, compares the combinational transformed data with the fourth storage data 44, and generates an advanced control signal S4. The advanced control signal S4 is transmitted to the control signal unit 5, and the control signal unit 5 controls the controlled component 71 of the electronic device 7 to generate a corresponding action through the advanced control signal S4. The electronic device 7 can be a robot, a massage chair, or other electronic devices controlled by a motor. In this embodiment, the electronic device 7 is implemented as a robot, the controlled component 71 is an action mechanism of the electronic device 7, and the fourth storage data 44 is stored as motor control commands for the robot to perform jumping dance. After the sound processing unit 3 generates the combinational transformed data for comparing with the fourth storage data 44, the sound processing unit 3 uses the advanced control signal S4 to control the robot to perform jumping dance action. Thereby, the sound processing unit 3 of the control system 1 is capable of processing the audio signal in real time when the audio playback device 8 generates the audio signal, and performing transformation through self-programmed motor control commands, and controlling the electronic device 7 to generate a corresponding motor operation mode within one second, so that the electronic device 7 is capable of instantaneously generating visual and tactile effects synchronized with the audio signal, and the electronic device 7 is also capable of instantaneously generating corresponding actions.

It is to be understood that the above description is only the preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. A structure for real-time audio signal processing and converting into a programmable control system comprising:
a sound processing unit, the sound processing unit comprising a first audio transforming module and a second audio transforming module, also the sound processing unit receiving an audio energy, the first audio transforming module capturing the audio energy and converting the audio energy into a first frequency value, the second audio transforming module capturing a frequency of the highest energy in the audio energy to generate a second frequency value, the sound processing unit capturing the audio energy and obtaining an audio energy value; and
a data storage unit, the data storage unit storing a plurality of first storage data, a plurality of second storage data, and a plurality of third storage data and being electrically connected to the sound processing unit, the sound processing unit comparing the first frequency value with the first storage data to generate a first control signal, the sound processing unit comparing the second frequency value with the second storage data to generate a second control signal, the sound processing unit comparing the audio energy value with the third storage data to generate a third control signal, and the sound processing unit transmitting the first control signal, the second control signal, and the third control signal to a control signal unit.

2. The structure for real-time audio signal processing and converting into the programmable control system as claimed in claim 1, further comprising an audio receiving unit, the audio receiving unit receiving an audio signal generated by at least one audio playback device and being electrically connected to the sound processing unit, and the sound processing unit receiving an audio energy of the audio signal.

3. The structure for real-time audio signal processing and converting into the programmable control system as claimed in claim 1, further comprising an electronic device, the electronic device being electrically connected to the control signal unit, the electronic device being provided with at least one controlled component, the control signal unit controlling the controlled component of the electronic device to generate a corresponding action through the first control signal, the second control signal, and the third control signal.

4. The structure for real-time audio signal processing and converting into the programmable control system as claimed in claim 1, wherein the first audio transforming module is fast Fourier transform filter detection.

5. The structure for real-time audio signal processing and converting into the programmable control system as claimed in claim 1, wherein the second audio transforming module is Mel-frequency filter bank filter detection.

6. The structure for real-time audio signal processing and converting into the programmable control system as claimed in claim 3, wherein the controlled component is a light-emitting element, and the first control signal controls the light-emitting element to generate a corresponding light color.

7. The structure for real-time audio signal processing and converting into the programmable control system as claimed in claim 3, wherein the controlled component is a light-emitting element, and the second control signal controls the light-emitting element to generate a corresponding light flickering rhythm.

8. The structure for real-time audio signal processing and converting into the programmable control system as claimed in claim 3, wherein the controlled component is a light-emitting element, and the third control signal controls the light-emitting element to generate a corresponding light brightness.

9. The structure for real-time audio signal processing and converting into the programmable control system as claimed in claim 3, wherein when the sound processing unit generates the first control signal, the second control signal, and the third control signal simultaneously, the sound processing unit further generates a combinational transformed data, the sound processing unit compares the combinational transformed data with a fourth storage data of the data storage unit to generate an advanced control signal, and the advanced control signal controls the controlled component of the electronic device to generate a corresponding action.

10. The structure for real-time audio signal processing and converting into the programmable control system as claimed in claim 9, further comprising a programming unit, the programming unit being electrically connected to the data storage unit, and the programming unit generating the first storage data, the second storage data, the third storage data, and the fourth storage data to be stored in the data storage unit.
